(19) United States
(12) Patent Application Publication
(10) Pub. No.: US 2024/0296518 A1
(43) Pub. Date: Sep. 5, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Sho SAITO, Saitama (JP)

(21) Appl. No.: 18/586,644

(22) Filed: Feb. 26, 2024

(30) Foreign Application Priority Data
Mar. 3, 2023 (JP) 2023-033073

(51) Int. Cl. G06T 3/4053; G06N 5/04; G06T 5/70

(52) U.S. Cl. CPC G06T 3/4053; G06N 5/04; G06T 5/70

(57) ABSTRACT

There is provided with an information processing method, Inference processing using a machine learning model having a first processing layer and a second processing layer a storing an intermediate output from the first processing layer is performed. A first intermediate output corresponding to a first input upon the first input being input into the first processing layer is output. An inference result upon (i) the first intermediate output and (ii) a second intermediate output from the first processing layer corresponding to a second input previous to the first input being input into the second processing layer, is output. The first intermediate output as the intermediate output is stored.

### BACKGROUND OF THE INVENTION

### Field of the Invention

The present invention relates to an information processing apparatus, an information processing method, and a storage medium.

### Description of the Related Art

In recent years, machine learning is being applied to various information processing application programs. Noise removal processing for restoring degraded images, super-resolution processing for improving visibility by increasing the resolution of an image and enhancing high-frequency components, Debayer processing for developing captured RAW images, and the like can be given as examples of information processing using machine learning.

Some machine learning models have multi-stage network structures. U.S. Pat. No. 11,151,694 and “FastDVDnet: Towards Real-Time Deep Video Denoising Without Flow Estimation”, Matias Tassano; Julie Delon; Thomas Veit, Proceedings of the IEEE/CVF Conference on Computer Vision and Pattern Recognition (CVPR), 2020, pp. 1354-1363, disclose a method for removing noise from a moving image using a model having a two-stage configuration, including a first noise removal unit and a second noise removal unit.

### SUMMARY OF THE INVENTION

According to one embodiment of the present invention, an information processing apparatus comprises: at least one processor; and a memory coupled to the at least one processor, the memory storing instructions that, when executed by the at least one processor, cause the at least one processor to: perform inference processing using a machine learning model having a first processing layer and a second processing layer; store an intermediate output from the first processing layer; output a first intermediate output corresponding to a first input upon the first input being input into the first processing layer; output an inference result upon (i) the first intermediate output and (ii) a second intermediate output from the first processing layer corresponding to a second input previous to the first input being input into the second processing layer; and store the first intermediate output as the intermediate output.

According to one embodiment of the present invention, an information processing method comprises: performing inference processing using a machine learning model having a first processing layer and a second processing layer; storing an intermediate output from the first processing layer; outputting a first intermediate output corresponding to a first input upon the first input being input into the first processing layer; outputting an inference result upon (i) the first intermediate output and (ii) a second intermediate output from the first processing layer corresponding to a second input previous to the first input being input into the second processing layer; and storing the first intermediate output as the intermediate output.

According to one embodiment of the present invention, a non-transitory computer readable storage medium storing a program that, when executed by a computer causes the computer to perform an information processing method comprises: performing inference processing using a machine learning model having a first processing layer and a second processing layer; storing an intermediate output from the first processing layer; outputting a first intermediate output corresponding to a first input upon the first input being input into the first processing layer; outputting an inference result upon (i) the first intermediate output and (ii) a second intermediate output from the first processing layer corresponding to a second input previous to the first input being input into the second processing layer; and storing the first intermediate output as the intermediate output.

Further features of the present invention will become apparent from the following description of exemplary embodiments (with reference to the attached drawings).

### BRIEF DESCRIPTION OF THE DRAWINGS

FIG. 1 is a block diagram illustrating an example of the configuration of an information processing system according to a first embodiment.

FIG. 2 is a block diagram illustrating an example of the functional configuration of an information processing apparatus according to the first embodiment.

FIGS. 3A and 3B are diagrams illustrating training processing in the information processing apparatus according to the first embodiment.

FIG. 4 is a diagram illustrating an example of the configuration of a model used by the information processing apparatus according to a first embodiment.

FIG. 5 is a diagram illustrating degradation addition processing according to the first embodiment.

FIG. 6 is a diagram illustrating an example of the network structure of a model according to the first embodiment.

FIG. 7A is a flowchart illustrating an example of training processing according to the first embodiment.

FIG. 7B is a flowchart illustrating an example of restoration processing according to the first embodiment.

FIG. 7C is a flowchart illustrating an example of model switching processing according to the first embodiment.

FIG. 8A is a block diagram illustrating an example of the input/output of a model according to a second embodiment.

FIG. 8B is a block diagram illustrating an example of the input/output of a model according to the second embodiment.

FIG. 8C is a block diagram illustrating an example of the input/output of a model according to the second embodiment.

FIGS. 9A and 9B are diagrams illustrating an example of the network structure of a model that performs pre-processing according to a third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

According to U.S. patent Ser. No. 11/151,694 and “FastDVDnet: Towards Real-Time Deep Video Denoising Without Flow Estimation”, Matias Tassano; Julie Delon; Thomas Veit, Proceedings of the IEEE/CVF Conference on Computer Vision and Pattern Recognition (CVPR), 2020, pp. 1354-1363, a plurality of frames in time series in a moving image are input, and noise removal is performed. At this time, first noise removal processing is performed using some of the plurality of input frames as a set, and second noise removal processing is performed by taking the result thereof as an input. For example, for five input frames, the first noise removal processing is performed three times, for a total of three sets each including three frames, and the second noise removal processing is performed by taking three intermediate outputs resulting from the first noise removal processing as inputs. However, with the techniques described in U.S. Pat. No. 11,151,694 and “FastDVDnet: Towards Real-Time Deep Video Denoising Without Flow Estimation”, Matias Tassano; Julie Delon; Thomas Veit, Proceedings of the IEEE/CVF Conference on Computer Vision and Pattern Recognition (CVPR), 2020, pp. 1354-1363, if the same processing is performed on five input frames that are input in sequence, two sets of input frames will be subjected to the same first noise removal processing as the previous time.

An object of the present invention is to more quickly perform information processing using a machine learning model.

In inference processing using a machine learning model having a first processing layer and a second processing layer, an information processing apparatus according to the present embodiment outputs an inference result by outputting a first intermediate output from a first input to the first processing layer, and then inputting, into the second processing layer, (i) the first intermediate output and (ii) a second intermediate output from the first processing layer corresponding to a second input previous to the first input.

### Convolutional Neural Network

The Convolutional Neural Network (CNN), which is used in a broad range of information processing technologies that apply deep learning and which is used in the following embodiments, will be described first. CNN is a mathematical model that repeats nonlinear operations after convolving filters generated through training or learning on image data. In a CNN, the data obtained by the nonlinear operations after convolving the input image data with a filter is called a feature map. The CNN is trained using training data (training images or data sets) constituted by pairs of input image data and output image data. In other words, using training data to generate filter values that can be converted from input image data to corresponding output image data with high accuracy is called “training”.

If the image data has RGB color channels, the feature map is constituted by multiple pieces of image data, or the like, the filter used for convolution has a plurality of channels in accordance therewith. In a CNN, the processing of nonlinear operations after convolving filters with image data (or feature maps) is expressed in units of layers, e.g., a feature map in an n-th layer or a filter in an n-th layer. For example, a CNN having a three-layer network structure repeats filter convolution and nonlinear operations three times. Such nonlinear operation processing can be formulated as in Formula (1) below.

$${X}_{n}^{( l )} = f ( {\sum }_{n = I}^{N} {W}_{n}^{( l )} * {X}_{n - 1}^{( l )} + {b}_{n}^{( l )} ) \qquad Formula ( 1 )$$

In Formula (1), Wₙ represents the filter in the n-th layer; bn, a bias of the n-th layer; f, a nonlinear operator; Xₙ, the feature map in the n-th layer; and *, a convolution operator. Note that (1) represents the 1-th filter or feature map. The filters and biases are generated by training and are collectively referred to as “network parameters”. A sigmoid function or Rectified Linear Unit (ReLU) is used for the nonlinear operation, for example. When ReLU is used, the nonlinear operation processing in a CNN can be given by the following Formula (2), for example.

$$f ( X ) = \{ \begin{matrix}X if 0 \leq X \\ 0 otherwise\end{matrix} \qquad Formula ( 2 )$$

As indicated by Formula (2), negative elements of an input vector X are zero, and elements greater than or equal to zero are left unchanged.

The Residual Network (ResNet), for the field of image recognition, and the application thereof in the field of super-resolution, RED-Net, can be given as examples of networks that utilize a CNN. In both of these, a high level of recognition accuracy is made possible by making the CNN multilayered and performing filter convolution many times. For example, ResNet features a network structure provided with shortcut paths through the convolutional layers, resulting in a 152-layer multilayer network that achieves recognition with accuracy that approaches human recognition rates. Multilayer CNNs improve recognition accuracy by repeating nonlinear operations many times to express nonlinear relationships between inputs and outputs.

### CNN Training

CNN training will be described next. A CNN is trained by minimizing an objective function expressed, for example, by the following Formula (3) for training data constituted by pairs of input image data and corresponding ground truth output image (supervisory image) data.

$$L ( θ ) = \frac{1}{n} {\sum }_{i = 1}^{n} {‖ F ( {X}_{i} ; θ ) - {Y}_{i} ‖}_{2}^{2} \qquad Formula ( 3 )$$

In Formula (3), L represents a loss function that measures the error between the ground truth and the inference result. Yᵢ represents the i-th ground truth output image data, and Xᵢ represents the i-th input image data. F is a function that collectively represents the operations performed at each layer of the CNN (Formula (1)). θ represents the network parameters (filter and bias). ||Z||₂ represents the L2 norm, i.e., the square root of the sum of squares of the elements of a vector Z. n represents the number of data sets in the training data. Since the number of pieces of training data is generally high, in Stochastic Gradient Descent (SGD), some of the training data is selected at random for use in the training. Various methods are known for minimizing (optimizing) the objective function, such as the momentum method, AdaGrad method, AdaDelta method, or Adam method. The Adam method can be given by Formula (4).

$$g = \frac{\partial L}{\partial {θ}_{i}^{t}} \qquad Formula ( 4 )$$

$${m}_{t} = {β}_{1} {m}_{t - 1} + ( 1 - {β}_{1} ) g$$

$${v}_{t} = {β}_{2} {v}_{t - 1} + ( 1 - {β}_{2} ) {g}^{2}$$

$${θ}_{i}^{t + 1} = {θ}_{i}^{t} - α \frac{\sqrt{1 - {β}_{2}}}{( 1 - {β}_{1} )} \frac{{m}_{t}}{\sqrt{{v}_{t} + ε}}$$

In Formula (4), t represents the value of a t-th iteration. θ₁^{t} represents the i-th network parameter at the t-th iteration, and g represents the gradient of the loss function L with respect to θ₁^{t}. m and v represent moment vectors, a represents a base learning rate, β₁ and β₂ represent hyperparameters, and ε represents a small constant. The method for optimization in the training is not limited thereto, and any publicly-known optimization technique can be applied. It is known that there are differences in the convergences of these methods, which produce different training times, and the optimization method can be selected according to the desired conditions.

The embodiments assume that information processing (image processing) for restoring a degraded image is performed using the CNN described above. Image degradation factors in this degraded image include, for example, degradation such as noise, blur, aberration, compression, low resolution, defects, and the like, as well as degradation such as a drop in contrast due to the effects of weather such as fog, haze, snow, and rain at the time of shooting. Image processing for restoring degraded images includes noise removal, blur removal, aberration correction, correction of degradation caused by compression, super-resolution processing for low-resolution images, defect compensation, and processing for correcting a drop in contrast caused by weather conditions at the time of shooting. The degraded image restoration processing according to the embodiments is processing for restoring an image by generating an image having no (or very little) degradation from an image having degradation, and will be referred to as image restoration (processing) in the following descriptions. In other words, image restoration in the embodiments includes not only processing for restoring of an image which itself has no (or little) degradation but which has been degraded by subsequent amplification, compression/decompression, or other image processing, but also processing for making it possible to reduce degradation in the original image itself.

Here, when using neural network-based image restoration processing, the expressive capabilities of the network are generally expected to be improved, and more accurate image restoration achieved, when a neural network having more parameters is used. On the other hand, more parameters lead to an increase in the number of operations, which increases the inference time and the amount of memory required for inference. The model that should be used in the image restoration processing therefore depends on the amount and usage state of the computational resources of the information processing apparatus performing the inference.

### First Embodiment

A first embodiment will describe an information processing apparatus that performs inference by storing an intermediate output from a first processing layer in a machine learning model that performs image restoration processing, and inputs a current intermediate output and a previous intermediate output to a second processing layer. The present embodiment will describe noise as an example of an image degradation factor, and processing for performing noise reduction processing as the image restoration processing.

### Example of Configuration of Information Processing System

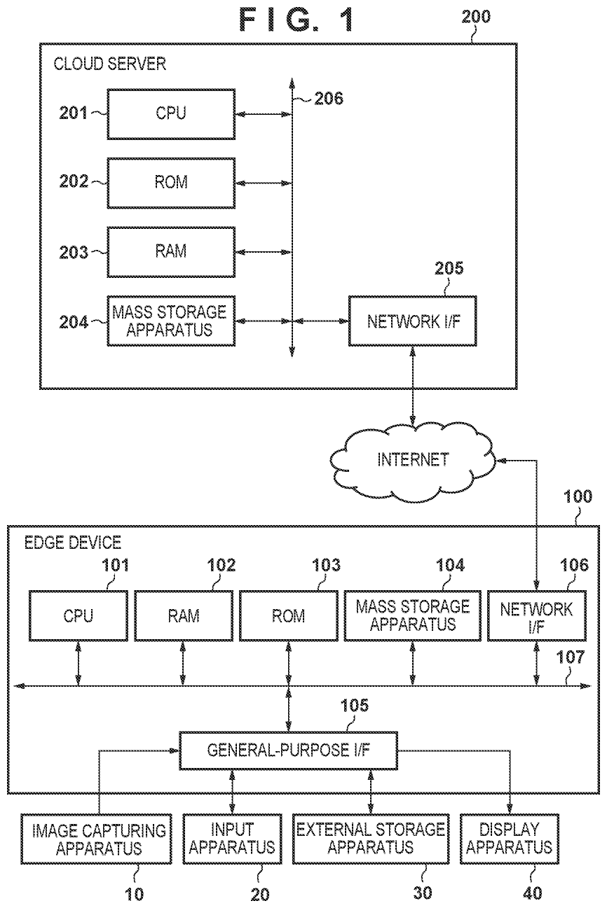

FIG. 1 is an example of an information processing system configuration including an information processing apparatus according to the first embodiment. In the information processing system illustrated in FIG. 1, a cloud server 200, which is responsible for generating training data and training for restoring image degradation, and an information processing apparatus 100 (an edge device 100), which is responsible for performing image restoration on an image to be processed, are communicatively connected to each other over the Internet or the like. In the following, the generation of training data and the training for restoring image degradation performed by the cloud server 200 will be referred to as “restoration training”, and restoration of a degraded image performed by the information processing apparatus 100 will be referred to as “restoration inference”. Note that although the present embodiment assumes that the cloud server 200 and the information processing apparatus 100 are separate apparatuses, the information processing apparatus 100 may perform the restoration training processing described as being performed by the cloud server 200.

### Hardware Configuration of Information Processing Apparatus

The information processing apparatus 100 obtains an image to be processed, and takes the obtained image as an input image to be input to a machine learning model that performs restoration inference. In the present embodiment, the information processing apparatus 100 may obtain RAW image data (in a Bayer array) input from an image capturing apparatus 10 as the input image subject to the image restoration processing. The image is not limited to any particular image format, such as the color space, and any format can be used. For example, this image may be image data in another color filter array, or may be a demosaiced RGB image or a YUV-converted image.

The information processing apparatus 100 performs restoration processing on a degraded image using a machine learning model, taking the input image to be processed as an input. The information processing apparatus 100 according to the present embodiment can perform restoration inference using a trained neural network model provided by the cloud server 200. In other words, the information processing apparatus 100 can be an information processing apparatus that reduces noise in RAW image data by executing a pre-installed information processing application program using a model provided by the cloud server 200.

The information processing apparatus 100 includes a CPU 101, a RAM 102, a ROM 103, a mass storage apparatus 104, a general-purpose interface (I/F) 105, and a network I/F 106, and these components are connected to each other by a system bus 107. The information processing apparatus 100 is also connected to the image capturing apparatus 10, an input apparatus 20, an external storage apparatus 30, and a display apparatus 40 via the general-purpose I/F 105.

Using the RAM 102 as a work memory, the CPU 101 executes programs stored in the ROM 103, and comprehensively controls each component in the information processing apparatus 100 via the system bus 107. The mass storage apparatus 104 is an HDD or an SSD, for example, and stores various types of data, image data, and so on handled by the information processing apparatus 100. The CPU 101 writes data to the mass storage apparatus 104, and reads out data stored in the mass storage apparatus 104, via the system bus 107. The general-purpose I/F 105 is a serial bus interface, such as USB, IEEE 1394, or HDMI (registered trademark), for example. The information processing apparatus 100 obtains data from the external storage apparatus 30 (e.g., various types of storage media such as a memory card, a CF card, an SD card, or a USB memory) via the general-purpose I/F 105.

The information processing apparatus 100 accepts user instructions from the input apparatus 20, which is a mouse or keyboard or a mobile terminal such as a smartphone, via the general-purpose I/F 105. The information processing apparatus 100 also outputs image data and the like processed by the CPU 101 to the display apparatus 40 (e.g., various types of image display devices, such as a liquid crystal display) via the general-purpose I/F 105. The display apparatus 40 can also function as the input apparatus 20 as a display apparatus integrated with a touch panel. The information processing apparatus 100 obtains the data of a captured image (RAW image) subject to the noise reduction processing from the image capturing apparatus 10 via the general-purpose I/F 105. The network I/F 106 is an interface for connecting to the Internet. The information processing apparatus 100 can obtain the trained model for restoration inference by accessing the cloud server 200 through an installed web browser.

### Hardware Configuration of Cloud Server

The cloud server 200 provides a machine learning model for performing restoration processing on a degraded image input to the information processing apparatus 100. The cloud server 200 according to the present embodiment is a server that provides a cloud service over the Internet. More specifically, the cloud server 200 generates training data and performs restoration training, and generates a trained machine learning model (a trained model) that stores network parameters and a network structure that are a result of the training. The cloud server 200 then provides the trained model in response to a request from the information processing apparatus 100. Hereinafter, the term “model” will be assumed to refer to this trained model.

The cloud server 200 includes a CPU 201, a ROM 202, a RAM 203, a mass storage apparatus 204, and a network I/F 205, and these components are connected to each other by a system bus 206. The CPU 201 controls the overall operations by reading out control programs stored in the ROM 202 and executing various types of processing. The RAM 203 is used as the main memory of the CPU 201, a temporary storage region such as a work area, or the like. The mass storage apparatus 204 is a high-capacity secondary storage device, such as an HDD or an SSD, in which image data or various types of programs are stored. The network I/F 205 is an interface for connecting to the Internet, and provides the trained model, which stores the network parameters and the network structure described above, in response to a request from the web browser of the information processing apparatus 100.

The present embodiment assumes that the information processing apparatus 100 downloads the trained model, which is the result of generating the training data and performing restoration training, from the cloud server 200, and performs restoration inference on the input image data to be processed. The components of the information processing apparatus 100 and the cloud server 200 that execute such processing may be realized by configurations other than those described above. For example, the functions handled by the cloud server 200 may be subdivided, and the generation of the training data and the restoration training may be executed by different apparatuses. Alternatively, the configuration may be such that the image capturing apparatus 10 provided with a combination of the functions of the information processing apparatus 100 and the cloud server 200 performs all of the operations for generating the training data, performing restoration training, and performing restoration inference.

### Function Blocks of Overall System

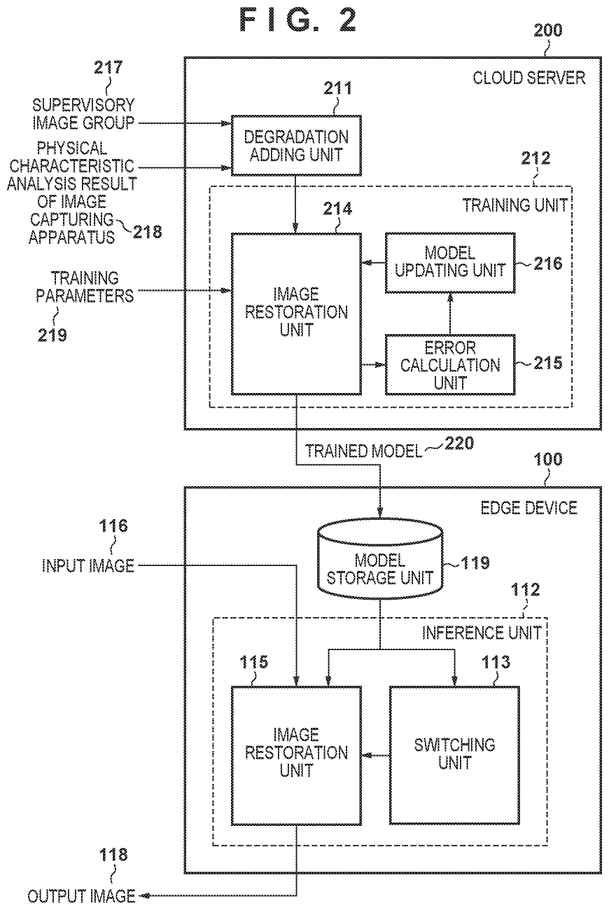

The overall functional configuration of the information processing system according to the present embodiment will be described next with reference to FIG. 2. As illustrated in FIG. 2, the information processing apparatus 100 includes an inference unit 112 and a model storage unit 119. The model storage unit 119 obtains a trained model 220 from the cloud server 200 and stores the model. The inference unit 112 has a function for image restoration processing for restoring a degraded image. The inference unit 112 includes an image restoration unit 115 and a storage unit 113 for inference.

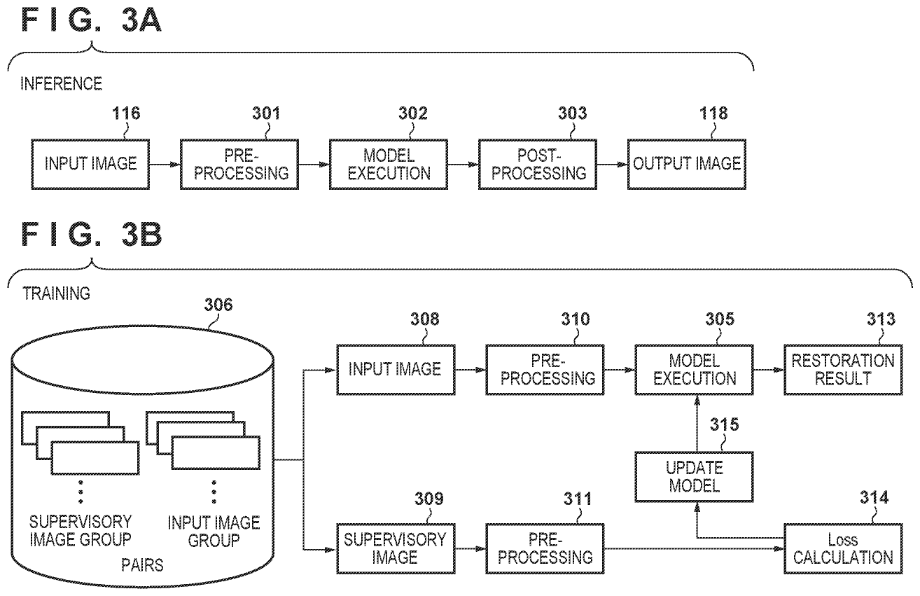

The image restoration unit 115 inputs a degraded image into the trained model 220 and restores the image. Here, processing performed by the image restoration unit 115 will be described with reference to FIG. 3A. The image restoration unit 115 obtains input image data 116 and executes pre-processing 301. The pre-processing 301 is processing performed before the input image data 116 is input to the trained model 220, and is, assuming the input image data is 14-bit integer values in a Bayer array, processing for converting each piece of data to a floating point number and normalizing the values to 0.0 to 1.0. Next, the image restoration unit 115 performs model execution 302 using the trained model 220, taking the data after the pre-processing 301 as the input. The image restoration unit 115 performs post-processing 303 on the result of the model execution 302 and obtains an output image 118. The post-processing 303 is processing performed on the output of the trained model 220, and is, when the model output result data is a floating point number, processing for converting the values to 14-bit integer values, for example.

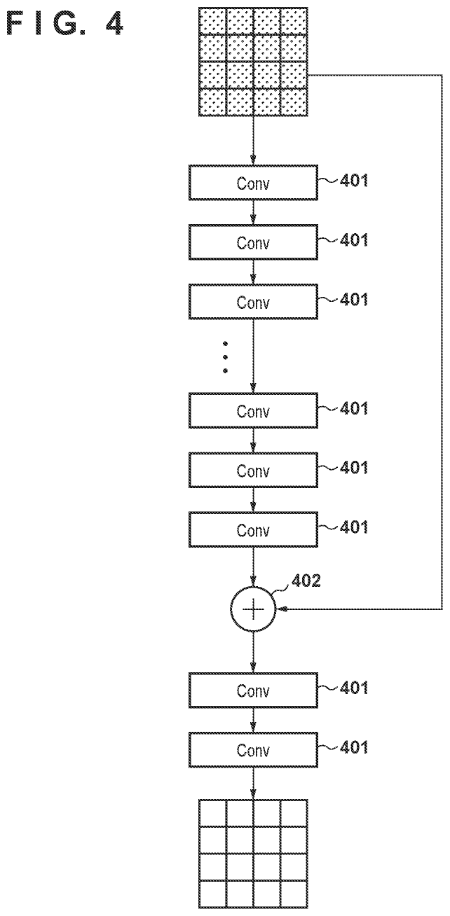

FIG. 4 is an example of the model structure. In this example, the model is constituted by a plurality of convolution layers 401 and connected layers 402. In the convolution layers 401, the convolution operation by the filter expressed by Formula (1) above and the nonlinear operation expressed by Formula (2) are repeated multiple times. The image restoration unit 115 applies the convolution layers 401 sequentially to the input data of the model and calculates a feature map. The image restoration unit 115 then connects the feature map and input data in the channel direction through the connected layers 402. Furthermore, the image restoration unit 115 applies the convolution layers 401 sequentially to the connection results and outputs a results from the final layer. The processing illustrated in FIG. 4 is processing commonly performed by CNNs and will therefore not be described in detail. The image restoration unit 115 performs restoration inference on the input image data 116 using the trained model 220 received from the cloud server 200.

The trained model 220 according to the present embodiment includes a first processing layer and a second processing layer, and outputs a model inference result from the second processing layer. The storage unit 113 stores an intermediate output, corresponding to an input, of the first processing layer of the trained model 220. It is assumed here that the intermediate output from the first processing layer, corresponding to an n-th input (where n is a natural number) input into the first processing layer, will be referred to as an “n-th intermediate output”.

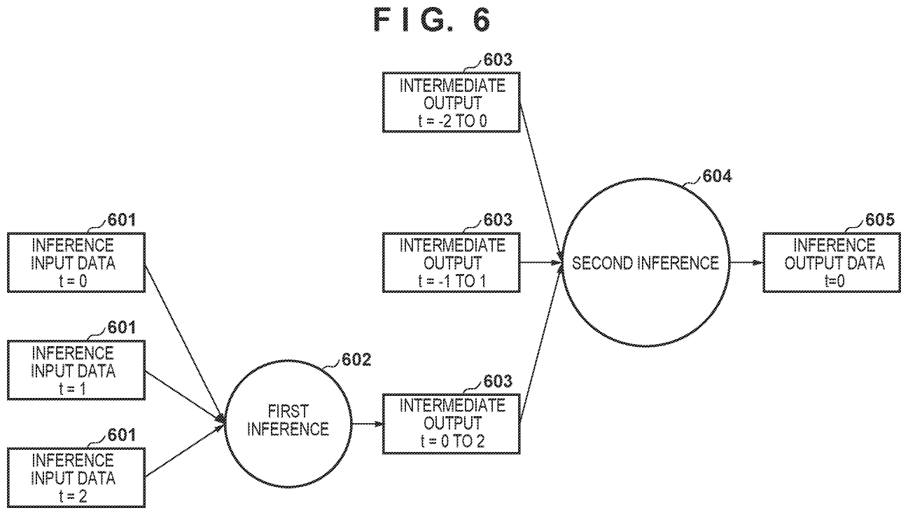

The image restoration unit 115 outputs the first intermediate output for the first input to the first processing layer, as described above. Next, the image restoration unit 115 inputs (i) the first intermediate output and (ii) a second intermediate output corresponding to a second input previous to the first input into the second processing layer, and outputs an inference result. Examples of the structures of the first processing layer and the second processing layer, as well as the processing performed in those processing layers, will be described later with reference to FIG. 6.

The cloud server 200 includes a degradation adding unit 211 and a training unit 212. The degradation adding unit 211 generates a degradation training image for input, which is used to train the restoration inference. For example, the degradation adding unit 211 can generate the degradation training image by adding at least one type of degradation factor to supervisory image data extracted from a group of supervisory images which do not have degradation. In the example of the present embodiment, noise is used as the degradation factor, and the degradation adding unit 211 generates the degradation training image data by adding noise as the degradation factor to the supervisory image data. In the present embodiment, the degradation adding unit 211 may generate the input image data by analyzing the physical characteristics of the image capturing apparatus and adding, to the supervisory image data, noise which corresponds to a degradation amount in a range broader than the degradation amount that can arise in the image capturing apparatus, as the degradation factor. Because there are different ranges for degradation amounts that can arise due to individual differences between image capturing apparatuses, adding a degradation amount in a broader range than the analysis result makes it possible to provide a margin and improve the robustness. Here, the supervisory images may be obtained from the image capturing apparatus 10, or may be obtained from an external device (not shown) over the Internet, for example.

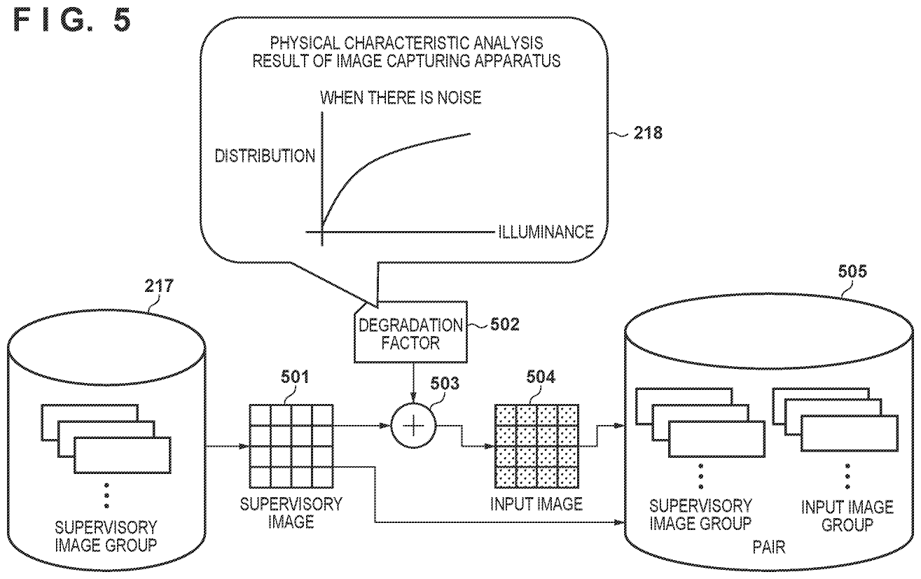

The addition of degradation will be described next with reference to FIG. 5. The degradation adding unit 211 generates degradation training image data 504 through addition 503 of noise, which is based on a physical characteristic analysis result 218 of the image capturing apparatus, as a degradation factor 502, to supervisory image data 501 extracted from a supervisory image group 217. The degradation adding unit 211 adds a pair constituted by the supervisory image data 501 and the degradation training image data 504 to training data 505. The degradation adding unit 211 generates a degradation training image group constituted by a plurality of pieces of the degradation training image data 504 by adding the degradation factor 502 for each piece of the supervisory image data in the supervisory image group 217, and generates the training data 505 using the generated degradation training image group. Although the present embodiment describes noise as an example, the degradation adding unit 211 may add, to the supervisory image data, any one or more of a plurality of types of degradation factors, such as blur, aberration, compression, low resolution, defects, drops in contrast caused by the weather at the time of shooting, and the like, as described earlier.

The supervisory image group 217 contains various types of image data, including, for example, nature photographs containing landscapes and animals, photographs of people such as portraits or sports photographs, photographs of man-made objects such as buildings and products, and the like. The supervisory image data according to the present embodiment is assumed to be RAW image data in which each pixel has a pixel value corresponding to one of the RGB colors, as in the input image data 116. The physical characteristic analysis result 218 of the image capturing apparatus includes, for example, the amount of noise produced by the image sensor built into the camera (image capturing apparatus) at each of sensitivities, the amount of aberration produced by the lens, or the like. These can be used to estimate the degree to which image degradation will arise at each of shooting conditions. In other words, adding the degradation estimated under given shooting conditions to the supervisory image data makes it possible to generate an image equivalent to the image obtained at the time of shooting.

Returning to the description of FIG. 2, the training unit 212 includes an image restoration unit 214, an error calculation unit 215, and a model updating unit 216 for training. The training unit 212 obtains training parameters 219 and performs restoration training using the training data generated by the degradation adding unit 211. The training parameters 219 include initial values of the parameters of the neural network model, the network structure of the model, and hyperparameters indicating an optimization method. The image restoration unit 214 performs image restoration processing on the input image. The error calculation unit 215 calculates error between an image restoration result image output by the image restoration unit 214 and the supervisory image. The model updating unit 216 updates the parameters of the neural network model of the image restoration unit 214 based on the calculated error.

FIG. 3B is a diagram illustrating the flow of the training processing performed by the training unit 212. The image restoration unit 214 performs the image restoration processing through model execution 305, using, as an input, data obtained through pre-processing 310 performed on input image data 308. In the model execution 305, the image restoration unit 214 repeats convolution operations and nonlinear operations with the filters expressed by Formula (1) and Formula (2) multiple times on the model input data, and outputs a restoration result 313. Next, by performing a Loss calculation 314 from data obtained by performing pre-processing 311 on supervisory image data 309 and the restoration result 313, the error calculation unit 215 calculates the error thereof. The model updating unit 216 then executes model updating 315 based on the error calculated by the error calculation unit 215, and updates the network parameters of the model so that the error is reduced (minimized).

Note that the inference processing and training processing described with reference to FIGS. 3A to 5 are examples, and different processing may be performed if the inference and training can be performed in the same way as when using a general CNN. Although the degradation training image is generated by the degradation adding unit 211 in the present embodiment, the training image may be prepared through a different method, such as obtaining the training image from an external device (not shown).

The configuration illustrated in FIG. 2 can be modified or changed as necessary. For example, one functional unit may be divided into a plurality of functional units, or two or more functional units may be integrated into one functional unit. The configuration illustrated in FIG. 2 may be realized by more than one device. In this case, the devices are connected via a circuit or a wired or wireless network, and operate cooperatively by communicating data with each other to realize the processing according to the present embodiment.

In the present embodiment, an inference result is output by the storage unit 113 storing the intermediate output from the first processing layer, and the image restoration unit 115 inputting the first intermediate output and the second intermediate output into the second processing layer. FIG. 6 is a schematic diagram illustrating the components of the networks in such candidate models. An examples of the network structure of the trained model 220 executed by the image restoration unit 115 will be described hereinafter with reference to FIG. 6.

In the example in FIG. 6, input data 601 input to the network of the trained model is data obtained by performing the pre-processing 301 on an input image 116 at each time (indicated by “t”). The example illustrated here is an example in which a plurality of frames input in sequence are arranged in time series in the input image 116, and output data (t=0) is output for the input image att=0. Meanwhile, for times relatively before the image at t=0, t has a negative value, and for times relatively after that image, t has a positive value. In FIG. 6, the output image at t=0 is output using five frames of input data, at t=−2 to 2.

The network illustrated in FIG. 6 takes five frames' worth of the input data 601 as an input and outputs one frame's worth of output data 605 as an inference result. The network structure illustrated in FIG. 6 has a two-stage structure in which first inference processing 602 is performed in the first processing layer and second inference processing 604 is performed in the second processing layer. Here, the image restoration unit 115 inputs three chronologically consecutive pieces of the input data 601 (t=0 to 2) into the first processing layer as a single set, and performs the first inference processing 602. Here, the storage unit 113 stores an intermediate output 603 (t=0 to 2), which is the result of the first inference processing. The intermediate output 603 is data in an image format, for example, but may be any data in a format that can be input to the subsequent second processing layer. The intermediate output may have different image characteristics, such as width, height, and channels, from the input data 601.

Here, the image restoration unit 115 inputs the intermediate output 603 (t =0 to 2) which has been output, and the two intermediate outputs 603 (t=−2 to 0, t=−1 to 1) output previously and stored in the storage unit 113, into the second processing layer, and outputs the output data 605 as an inference result. In other words, the intermediate outputs 603 (t=−2 to 0, t=−1 to 1), which are intermediate outputs from the past, are stored in the storage unit 113, and the inference processing in the second processing layer is performed by carrying over these past intermediate outputs 603 in addition to the current intermediate output 603 (t=0 to 2). Hereinafter, the intermediate output (and the processing for outputting the intermediate output) not carried over here (i.e., using the input data 601 at t=0 to 2) may be referred to as the “current” intermediate output (processing), and the intermediate outputs carried over may be referred to as “previous” intermediate outputs. In addition, for the current intermediate output, the intermediate output from one unit frame previous (here, where the data at t=−1 to 1 is taken as the input) may be referred to as the intermediate output “one previous”, and the intermediate output from two unit frames previous (here, where the data at t=−2 to 0 is taken as the input) may be referred to as the intermediate output “two previous”. The “unit frame” is the smallest unit of the plurality of frames arranged in time series and sequentially input to the trained model 220.

A plurality of pieces of input data 601 and a single piece of output data 605 are used in the examples in FIGS. 6A to 6E. However, the present embodiment is not limited to this example, and the number of pieces of input data and the number of pieces of output data may be one or more, respectively, and the output data 605 may be an output corresponding to a different time in the input data instead of t=0. In addition, although FIGS. 6A to 6E illustrate chronologically continuous data as the input data 601, the data need not be chronologically continuous data.

### Flow of Processing in Overall System

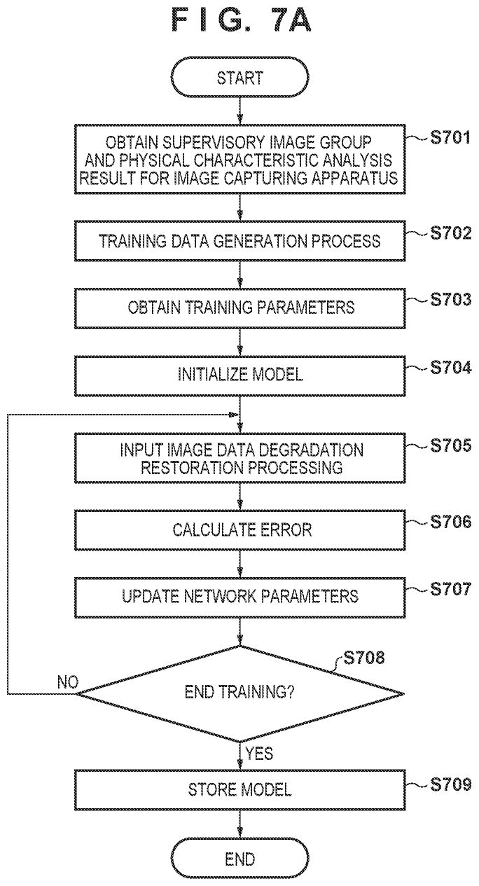

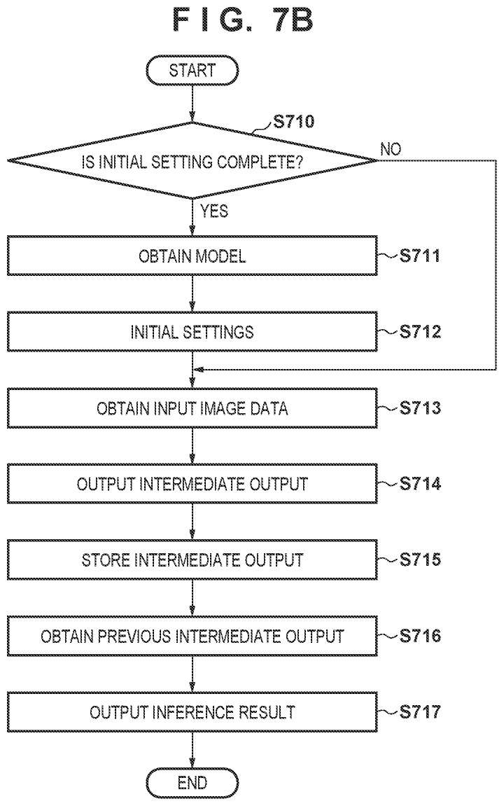

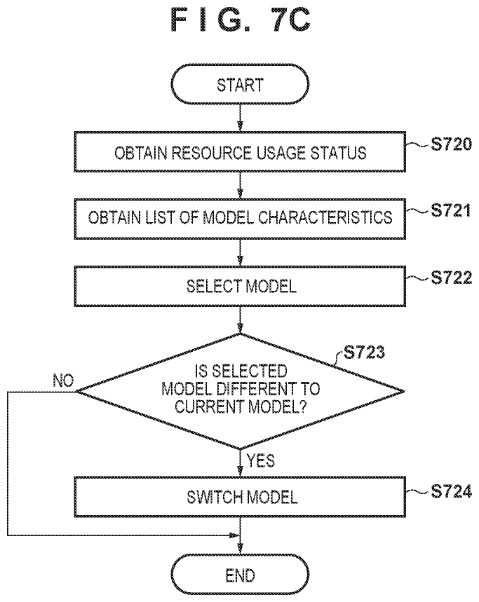

The various processing performed by the information processing system according to the present embodiment will be described next with reference to FIGS. 7A to 7C. FIGS. 7A to 7C are flowcharts illustrating an example of the processing performed by the information processing system according to the present embodiment. The functional units illustrated in FIG. 2 are realized by the CPU 101 or 201 executing information processing computer programs according to the present embodiment. However, some or all of the functional units illustrated in FIG. 2 may be implemented by hardware. Descriptions will be given hereinafter with reference to the flowcharts illustrated in FIGS. 7A to 7C. Note that in the following descriptions, “S” indicates a processing step. An example of the flow of the restoration training performed by the cloud server 200 will be described first with reference to the flowchart in FIG. 7A. In S701, the supervisory image group 217 prepared in advance, as well as the physical characteristic analysis result 218 for the image capturing apparatus 10, such as the characteristics of the image sensor, the sensitivity at the time of shooting, the subject distance, the lens focal length and F-number, and the exposure value, are input to the cloud server 200. Note that the supervisory image data is assumed to be Bayer-array RAW images, which are obtained by capturing images using the image capturing apparatus 10. However, the method for obtaining the supervisory image group 217 is not particularly limited, and for example, images captured in advance may be stored in an HDD or the like and uploaded to the server.

In S702, the degradation adding unit 211 generates degradation training image data by adding noise based on the physical characteristic analysis result 218 of the image capturing apparatus to the supervisory image data of the supervisory image group 217 input in S701 as a degradation factor. Here, it is assumed that the degradation adding unit 211 adds, to the supervisory image data, an amount of noise measured in advance based on the physical characteristic analysis result 218 of the image capturing apparatus, either in a preset order or in a random order.

In S703, the training unit 212 obtains the training parameters 219 to be applied in the restoration training. The training parameters here include the initial values of the parameters of the neural network model, the network structure of the model, and the hyperparameters indicating the optimization method, as described earlier. In S704, the image restoration unit 214 makes initial settings for the model using the received network parameters.

In S705, the image restoration unit 214 performs restoration processing on the degradation training image data, using the degradation training image data as an input to the model. Using a machine learning model having, for example, the first processing layer and the second processing layer, such as that illustrated in FIG. 6, the image restoration unit 214 performs restoration processing by inputting the first (current) intermediate output from the first processing layer and the second intermediate output previous to the first intermediate output into the second processing layer.

In S706, the error calculation unit 215 calculates the error between the result of the restoration in S705 and the supervisory image data according to the loss function indicated by Formula (3). In 7907, the model updating unit 216 updates the network parameters of the model so as to reduce (minimize) the error obtained in S706. Here, the model updating unit 216 updates the parameters not only for the current intermediate output, but also updates the parameters using the previous intermediate output. By performing the training in this manner, the parameters of the model can be updated more efficiently without wasting computation time required to output the previous intermediate output.

In S708, the training unit 212 determines whether to end the training. For example, the training unit 212 determines to end the training when the number of network parameter updates has reached a predetermined number, or when a predetermined period has passed following the start of the training. The sequence moves to S709 if the training is to be ended, and returns to S705 if the training is not to be ended. In the second and subsequent iterations of S705 to S708, the training is continued using unprocessed degradation training image data and supervisory image data. In S709, the training unit 212 stores the trained model in the mass storage apparatus 204 or the like.

An example of the flow of restoration inference processing performed by the information processing apparatus 100 will be described next with reference to the flowchart in FIG. 7B. In S710, the image restoration unit 115 determines whether initial settings have been made for the network model to be used for inference. If so, the sequence moves to S713, and if not, the sequence moves to S711. In S711, the model storage unit 119 obtains the trained model 220 from the cloud server 200 and stores the model.

In S712, the image restoration unit 115 makes initial settings for the model to be used for inference in order to start the inference using the trained model 220 stored in the model storage unit 119. Using a machine learning model having, for example, the first processing layer and the second processing layer, such as that illustrated in FIG. 6, the image restoration unit 214 performs restoration processing by inputting the first (current) intermediate output from the first processing layer and the second intermediate output previous to the first intermediate output into the second processing layer.

In S714, the information processing apparatus 100 obtains the input image data 116, which is a Bayer-array RAW image to be subject to the image restoration processing. As the RAW image, an image captured by the image capturing apparatus 10 may be input directly, or an image captured in advance and stored in the mass storage apparatus 104 may be read out, for example. Here, at least the number of frames input into the first processing layer in S714 is obtained as the input image data 116.

In S714, the image restoration unit 115 inputs the input image data 116 into the first processing layer of the trained model 220, and outputs an intermediate output. In step S715, the storage unit 113 stores the intermediate output output in step S714 along with information associated with that input. Here, the storage unit 113 can store the intermediate output along with information indicating the timing of the input, e.g., t=0 to 2, but this information is not limited thereto as long as the image restoration unit 115 can determine to which input the intermediate output corresponds.

In S716, the image restoration unit 115 obtains the previous intermediate output stored in the storage unit 113. In the example in FIG. 6, an intermediate output corresponding to the input image data 116 where t=0 to 2 is output in S714, and intermediate outputs corresponding to the input image data 116 where t =−2 to 0 and t=−1 to 1 are obtained in S716. In S717, the image restoration unit 115 inputs the intermediate output output in S714 and the intermediate outputs obtained in S716 into the second processing layer of the trained model 220, and outputs an inference result from the model. In S717, the image data restored by the image restoration unit 115 is output as output image data 118, after which the processing illustrated in FIG. 7B ends.

The foregoing has described the overall flow of processing performed by the information processing system according to the present embodiment. According to such processing, the inference can be performed by storing the intermediate output from the first processing layer in the machine learning model, and then inputting the current intermediate output and the previous intermediate output into the second processing layer. Accordingly, performing the processing having carried over previous intermediate outputs makes it possible to accelerate the inference processing.

Note that the information processing apparatus 100 may store a plurality of trained models 220 in the model storage unit 119, and switch the models to perform the inference when a predetermined condition (a switching condition) is satisfied. For example, the information processing apparatus 100 can take the switching condition as being satisfied when the usage state of resources during inference is a predetermined state (e.g., when the resource usage rate exceeds 90%). In this manner, switching the model used to a model that consumes fewer resources during inference, for example, in response to the usage state of the resources being a predetermined state makes it possible to perform the inference processing having selected a more appropriate model. Accordingly, the image restoration unit 115 may set a ranking for each characteristic, such as resource consumption during inference or the like, for each trained model 220 stored, and switch the model to be used in accordance with the set ranking when a switching condition pertaining to that characteristic is satisfied. Switching models in this manner will be described with reference to FIG. 7C.

The flowchart in FIG. 7C is a flowchart illustrating an example of model switching processing performed by the image restoration unit 115. The processing in FIG. 7C can be performed before S713, for example.

In S720, the image restoration unit 115 obtains the resource usage state. In S721, the image restoration unit 115 obtains the model characteristics of the trained model 220 stored in the model storage unit 119. Various items such as inference accuracy, memory usage, or the like can be given in addition to the resource consumption during inference described above. In S722, based on the resource usage state obtained in S720 and the model characteristics obtained in S721, the switching unit 113 selects the model to be used for the next inference (the model to be switched to) from among the trained models 220 stored in the model storage unit 119. Here, the image restoration unit 115 may, for example, set a rank among the models for the item “amount of resources consumed during inference” in the model characteristics, and then switch to a model ranked one place below the model currently being used when the resource usage rate exceeds a predetermined threshold.

In S723, the switching unit 113 determines whether the model selected in S722 is different from the model currently being used. If the models are different, the sequence moves to S724, whereas if the models are the same, the processing ends. In S724, the switching unit 113 switches the model used by the image restoration unit 115 to the model selected in S722, and ends the processing. Although the present embodiment describes generating the training data in S702, the training data may be generated later. Specifically, the configuration may be such that the input image data corresponding to the supervisory image data is generated in the subsequent restoration training. In addition, although the present embodiment describes the cloud server 200 as performing training from scratch using the data of a supervisory image group prepared in advance, a machine learning model having trained network parameters may be obtained and the processing may then be performed using that model.

Although the present embodiment describes the processing as being performed using noise as the degradation factor, similar processing can be performed even when a degradation factor other than noise is used. For example, as described above, blur, aberration, compression, low resolution, defects, or the like, or a drop in contrast caused by fog, haze, snow, rain, or the like at the time of shooting, may be used as the degradation factor, or a plurality of combinations thereof may be used.

Although the present embodiment describes an example in which the information processing apparatus 100 uses the trained model to perform restoration based only on the input image data, additional parameters that assist in image restoration may be used as well. For example, the information processing apparatus 100 may store, in advance, a lookup table which provides estimates on the extent to which image quality degradation is expected to occur depending on shooting conditions such as the distance to the subject, the focal length, the sensor size, the exposure, or the like, and may adjust a restoration amount by referring to the lookup table when restoring the image. In other words, the inference unit 112 of the information processing apparatus 100 may adjust the restoration strength for degradation based on the shooting conditions under which the image in the input image data was shot.

Although the present embodiment describes an example in which a machine learning model that performs image restoration processing is used, the task of the model is not limited to image restoration processing, and processing can be performed in the same manner even when using a model that performs image recognition or the like, for example.

### Second Embodiment

The first embodiment described an example of an information processing apparatus that carries over a predetermined number of previous intermediate outputs to the second processing layer. Compared to the configuration described in the first embodiment, an information processing apparatus according to the second embodiment changes an interval or number of intermediate outputs input into the second processing layer in the inference. The basic configuration of the information processing system and the functional configuration of the information processing apparatus 100 are the same as those described in the first embodiment, and thus identical details will not be described.

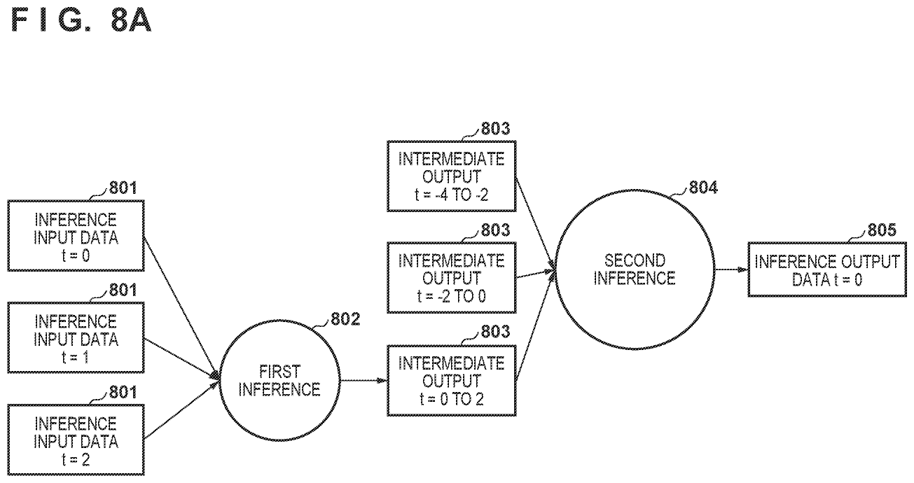

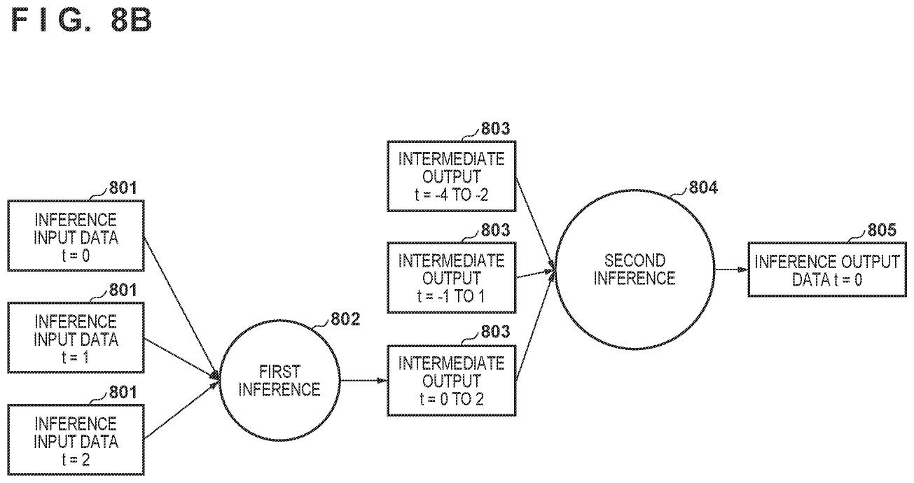

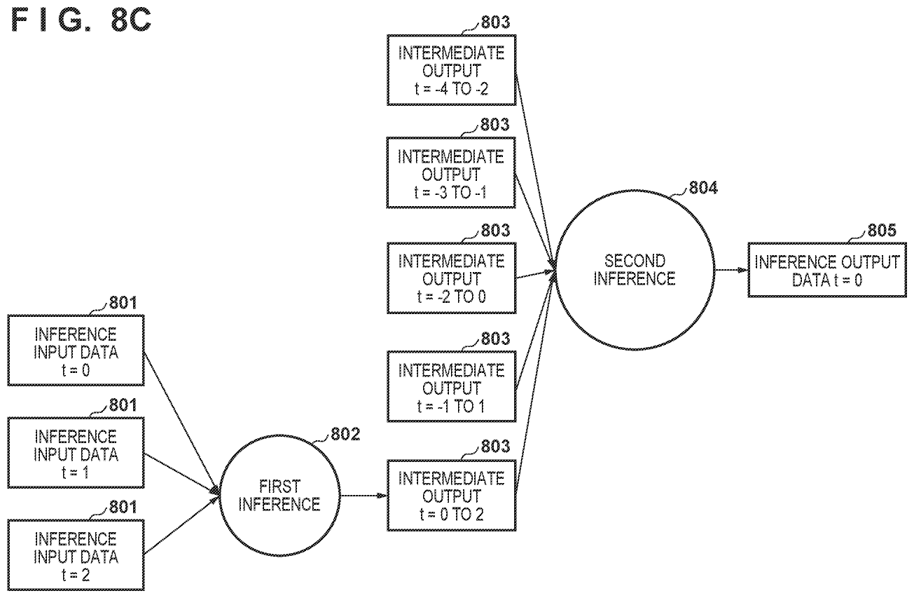

A model that discretely uses carried-over intermediate outputs from regular intervals in the past, a model that discretely uses carried-over intermediate outputs from irregular intervals in the past, and a model in which the number of carried-over intermediate outputs is variable, according to the present embodiment, will be described hereinafter with reference to FIGS. 8A to 8C. Note that the inference processing performed by the models according to the present embodiment is assumed to be super-resolution processing.

Like the model illustrated in FIG. 6, the models in FIG. 8A to FIG. 8C are networks having a two-stage configuration including a first processing layer and a second processing layer. Like the model illustrated in FIG. 6, in the models of the present embodiment illustrated in FIGS. 8A to 8C, three frames of input data 801 are input into the first processing layer as the first input, and first intermediate output 803 is output. The intermediate output 803 may be, for example, data having a higher number of channels than the image input. In the networks illustrated in FIGS. 8A to 8C, previous intermediate outputs are input into the second processing layer in addition to the first intermediate output, and output data 805 is output as an inference result. The differences between the network model illustrated in FIG. 6 and the networks illustrated in FIGS. 8A to 8C will be described next.

In the network illustrated in FIG. 6, inference is performed by inputting the intermediate output one previous (t=−1 to 1) and the intermediate output two previous (t=−2 to 0) into the second processing layer in addition to the current intermediate output (t=2 to 0). Here, the interval between the intermediate outputs in the network illustrated in FIG. 6 is one unit frame. However, the network illustrated in FIG. 8A is a model that discretely uses carried-over intermediate outputs from regular intervals in the past. In other words, in the network illustrated in FIG. 8A, inference is performed by inputting the intermediate output two previous (t=−2 to 0) and the intermediate output four previous (t=−4 to −2) into the second processing layer in addition to the current intermediate output (t=0 to 2). In this manner, the information processing apparatus 100 according to the present embodiment can set an interval between the first input and the second input, and input, into the second processing layer, the second intermediate output corresponding to the second input designated by the set interval for the first input. For example, compared to the network in FIG. 6, by making the interval between the intermediate outputs input into the second processing layer longer, as in the network of FIG. 8A, the inference processing can be performed using information from a longer period of time, even when carrying over the same number of intermediate outputs. In the following, the interval, for intermediate outputs, between the inputs input into the first processing layer in order to output those intermediate outputs will be referred to as an “interval of intermediate outputs”.

In the network illustrated in FIG. 6, two intermediate outputs stored for the first input are obtained at one-frame intervals, whereas in the network illustrated in FIG. 8A, two intermediate outputs stored for the first input are obtained at two-frame intervals. However, the image restoration unit 115 does not need to set the interval between the intermediate outputs to be obtained (the second intermediate output) to a constant interval. For example, the image restoration unit 115 may obtain a second intermediate output corresponding to a second input that was input previous to the first input by a first interval, and a third intermediate output corresponding to a third input that was input previous to the second input by a second interval (different from the first interval). The image restoration unit 115 may input the second intermediate output and the third intermediate output obtained in this manner, and the first intermediate output, into the second processing layer, and output an inference result.

FIG. 8B illustrates a model in which the current intermediate output 803, and the stored intermediate output 803 obtained at such unequal intervals, are input into the second processing layer. In the network illustrated in FIG. 8B, inference is performed by inputting the intermediate output one previous (t=−1 to 1) and the intermediate output four previous (t=−4 to −2) into the second processing layer in addition to the current intermediate output. Making the interval at which the intermediate output is obtained denser in frames that are relatively close to the current frame (to be processed) than for other frames in this manner makes it possible to perform the inference processing using intermediate outputs that are more relevant to the frame to be processed. Although an example in which the first interval is shorter than the second interval has been described here, the implementation may be different, such as setting the second interval to be shorter than the first interval when the information closest to the frame to be processed is relatively unnecessary.

In addition, the models illustrated in FIGS. 6, 8A, and 8B all input a total of three intermediate outputs into the second processing layer (i.e., two stored intermediate outputs are obtained and carried over). However, the number of intermediate outputs to be carried over is not limited, and in particular, the number may be changed according to conditions. In other words, the image restoration unit 115 according to the present embodiment can change the number of intermediate outputs to be carried over in accordance with a predetermined condition (changing condition) being satisfied.

FIG. 8C illustrates an example of a model that performs inference by inputting a total of five intermediate outputs (carrying over four) into the second processing layer. Although three intermediate outputs are input into the second processing layer in the model in FIG. 6, inputting five intermediate outputs into the second processing layer makes it possible to increase the amount of information and improve the accuracy of the inference. On the other hand, reducing the number of intermediate outputs input into the second processing layer makes it possible to reduce the amount of information input so as to reduce the processing load of the inference.

The above-described change condition may be, for example, whether the user has entered a change to the settings. For example, the image restoration unit 115 may obtain user inputs for various settings, such as whether the user prioritizes speed or accuracy in the inference, through the input apparatus 20, and change the number of intermediate outputs obtained (carried over) for input into the second processing layer in accordance with the settings. In this example, the image restoration unit 115 can reduce the number of intermediate outputs carried over when the setting has been changed to prioritize speed in the inference, and increase the number of intermediate outputs carried over when the setting has been changed to prioritize accuracy in the inference. For example, the image restoration unit 115 may evaluate the processing load in the inference, and change the number of intermediate outputs carried over when the evaluation of the processing load has become a predetermined state. For example, this reduces the number of intermediate outputs carried over in a high-load state, such as when the resource usage rate exceeds a predetermined threshold, and, conversely, increases the number of intermediate outputs carried over in a low-load state, such as when the resource usage rate is less than the predetermined threshold.

Furthermore, for example, the image restoration unit 115 may increase the number of intermediate outputs carried over when a condition that the accuracy is to be improved is satisfied, such as when a predetermined subject set for super-resolution processing at a high level of accuracy has been detected. Here, the predetermined subject can be detected through a publicly-known detection technique, and detailed descriptions thereof will therefore be omitted.

Note that in the present embodiment, even if the number of intermediate outputs carried over is changed, information on the intermediate outputs stored in the storage unit 113 is retained, and inference processing by the second processing layer is performed using the stored intermediate outputs even after the number is changed. Such processing makes it possible to continue processing without restoring the intermediate outputs even if the number of intermediate outputs carried over is changed, and reduce the processing time compared to a case where the intermediate outputs are restored.

### Third Embodiment

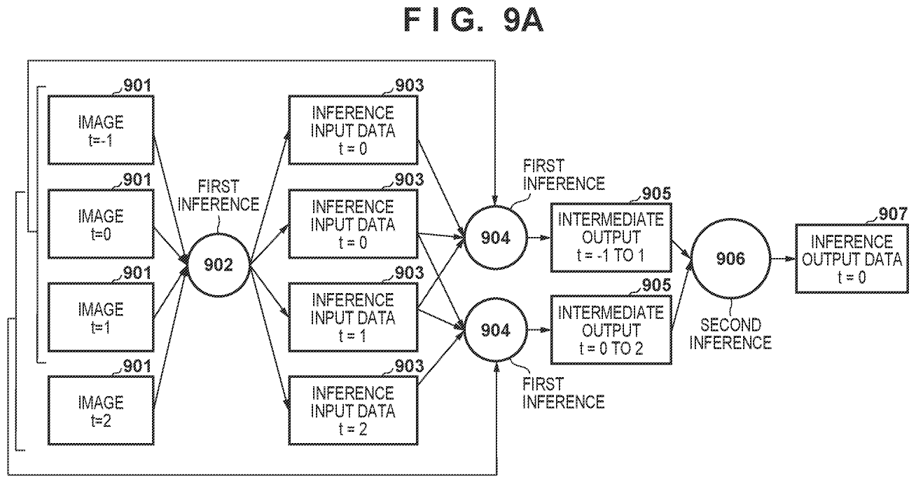

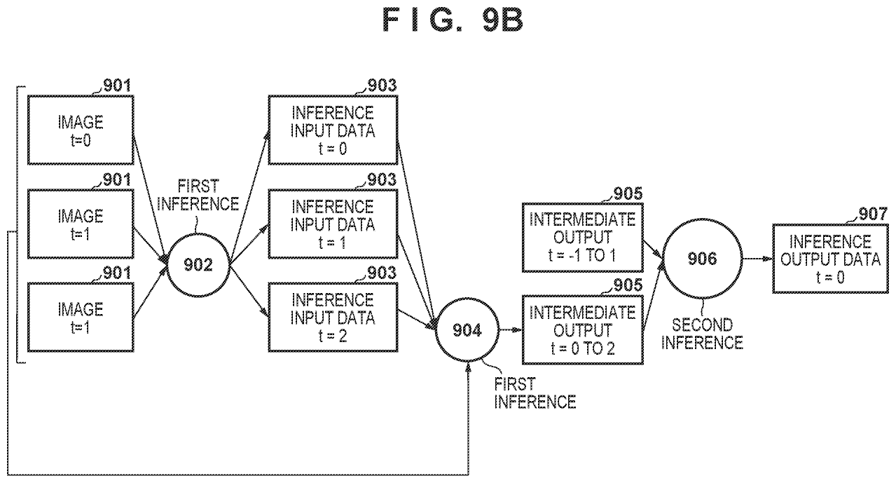

A case where results of the intermediate outputs up to the previous instance cannot be carried over will be described with reference to FIGS. 9A and 9B. The network illustrated in FIGS. 9A and 9B has a three-stage configuration in which an additional processing layer is provided before the first processing layer according to the first embodiment, and in the present embodiment, this additional processing layer is referred to as a “0-th processing layer”. In the 0-th processing layer, a plurality of pieces of image data 901 are input as a set, and inference input data 903 is output. In the present embodiment, pre-processing is performed in the 0-th processing layer, before the information processing by the first processing layer and the second processing layer. Here, the inference input data 903 output from the 0-th processing layer is auxiliary information different from the image and useful for performing desired image processing (Debayering). In FIG. 9A, four frames' worth of image data (t=−1 to 2) is input to the 0-th processing layer as a set, and four corresponding pieces of inference output data (t =−1 to 2) are output. Additionally, in FIG. 9B, three frames' worth of image data (t=0 to 2) is input to the 0-th processing layer as a set, and three corresponding pieces of inference output data (t=0 to 2) are output. Three pieces of inference input data are input into the first processing layer as a set, and one intermediate output 905 is output for that set. In other words, two intermediate outputs 905 corresponding to t=−1 to 1 and t=0 to 2 are output in FIG. 9A, and one intermediate output 905 corresponding to t=0 to 2 is output in FIG. 9B.

Here, in the example illustrated in FIG. 9A, the intermediate output corresponding to t=−1 to 1 is different between the previous processing and the current processing, and thus the previous intermediate output cannot be carried over in the second processing layer as in the first embodiment. This is because the inference input data 903 corresponding to t=−1 to 1 output from the 0-th processing layer currently is different when four frames' worth of image data t=−2 to 1 is input to the 0-th processing layer in the previous processing. On the other hand, according to the structure of the network model illustrated in FIG. 9B, the inference processing can be accelerated by performing the processing having carried over past intermediate outputs as in the first embodiment while performing pre-processing (the 0-th processing) that makes the same number of outputs as the number of pieces of data input to the trained model 220.

Note that the processing performed in the first processing layer and the second processing layer according to the present embodiment is the same as in the first embodiment, and will therefore not be described here. Additionally, although it is assumed that the trained model 220 according to the present embodiment performs Debayer processing that converts information input to the machine learning model into an image as the inference processing, the processing is not particularly limited thereto.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-033073, filed Mar. 3, 2023, which is hereby incorporated by reference herein in its entirety.

What is claimed is:

1. An information processing apparatus comprising:
at least one processor; and
a memory coupled to the at least one processor, the memory storing instructions that, when executed by the at least one processor, cause the at least one processor to:
perform inference processing using a machine learning model having a first processing layer and a second processing layer;
store an intermediate output from the first processing layer;
output a first intermediate output corresponding to a first input upon the first input being input into the first processing layer;
output an inference result upon (i) the first intermediate output and (ii) a second intermediate output from the first processing layer corresponding to a second input previous to the first input being input into the second processing layer; and
store the first intermediate output as the intermediate output.

2. The information processing apparatus according to claim 1,
wherein (i) the first intermediate output, (ii) the second intermediate output, and (iii) a third intermediate output from the first processing layer, corresponding to a third input previous to the second input, are input into the second processing layer, and
a first interval at which the first input and the second input are input into the first processing layer is equal to a second interval at which the second input and the third input are input into the first processing layer.

3. The information processing apparatus according to claim 1,
wherein the instructions cause the at least one processor to set the first interval and the second interval.

4. The information processing apparatus according to claim 3,
wherein each of the first interval and the second interval is an interval corresponding to a number of unit frames of image data sequentially input into the machine learning model.

5. The information processing apparatus according to claim 1,
wherein (i) the first intermediate output, (ii) the second intermediate output, and (iii) a third intermediate output from the first processing layer, corresponding to a third input previous to the second input, are input into the second processing layer, and
a first interval at which the first input and the second input are input into the first processing layer is different from a second interval at which the second input and the third input are input into the first processing layer.

6. The information processing apparatus according to claim 5,
wherein the first interval is shorter than the second interval.

7. The information processing apparatus according to claim 1,
wherein the instructions cause the at least one processor to set a total number of the second intermediate outputs input into the second processing layer.

8. The information processing apparatus according to claim 7,
wherein the instructions cause the at least one processor to:
detect a predetermined subject from an image input to the machine learning model; and
set the total number of the second intermediate outputs input into the second processing layer to be higher when the predetermined subject is detected than when the predetermined subject is not detected.

9. The information processing apparatus according to claim 7,
wherein the instructions cause the at least one processor to:
evaluate a processing load in the inference; and
change the total number of second intermediate outputs input into the second processing layer when the evaluation of the processing load has become a predetermined state.

10. The information processing apparatus according to claim 1,
wherein the machine learning model further includes a third processing layer before the first processing layer, and
the instructions cause the at least one processor to output the first input by inputting a same number of the third inputs as the first input to the third processing layer.

11. The information processing apparatus according to claim 1,
wherein the instructions cause the at least one processor to:
update a parameter of the machine learning model; and
update the parameter based on (i) a third intermediate output from the first processing layer in response to a fourth input and (ii) a fourth intermediate output, from the first processing layer, that corresponds to a fifth input previous to the fourth input.

12. The information processing apparatus according to claim 1,
wherein the inference is processing for restoring a degraded image that is input.

13. The information processing apparatus according to claim 1,
wherein the inference is super-resolution processing that restores information of an image input to the machine learning model.

14. The information processing apparatus according to claim 1,
wherein the inference is Debayer processing that converts information input to the machine learning model into an image.

15. An information processing method comprising:
performing inference processing using a machine learning model having a first processing layer and a second processing layer;
storing an intermediate output from the first processing layer;
outputting a first intermediate output corresponding to a first input upon the first input being input into the first processing layer;
outputting an inference result upon (i) the first intermediate output and (ii) a second intermediate output from the first processing layer corresponding to a second input previous to the first input being input into the second processing layer; and
storing the first intermediate output as the intermediate output.

16. A non-transitory computer readable storage medium storing a program that, when executed by a computer causes the computer to perform an information processing method comprising:
performing inference processing using a machine learning model having a first processing layer and a second processing layer;
storing an intermediate output from the first processing layer;
outputting a first intermediate output corresponding to a first input upon the first input being input into the first processing layer;
outputting an inference result upon (i) the first intermediate output and (ii) a second intermediate output from the first processing layer corresponding to a second input previous to the first input being input into the second processing layer; and
storing the first intermediate output as the intermediate output.
